(19) United States
(12) Patent Application Publication
(10) Pub. No.: US 2010/0035631 A1
(43) Pub. Date: Feb. 11, 2010

(54) Systems and Methods to Record and Present a Trip

(75) Inventors: Justin Doucette, Glendale, CA (US); Stig Pedersen, Los Angeles, CA (US); Oleg Perezhogin, Ottawa (CA)

Correspondence Address: GREENBERG TRAURIG, LLP (SV);IP DOCKETING, 2450 COLORADO AVENUE, SUITE 400E, SANTA MONICA, CA, 90404, US

(73) Assignee: MAGELLAN NAVIGATION, INC., Santa Clara, CA (US)

(21) Appl. No.: 12/188,139

(22) Filed: Aug. 7, 2008

(51) Int. Cl. H04W 24/00

(52) U.S. Cl. 455/456.1

(57) ABSTRACT

A method, machine-readable medium and apparatus for determining a sequence of locations; generating one or more objects, each of the one or more objects being at least partially generated at one or more corresponding locations in the sequence of locations; and associating each of the objects with at least one of the one or more corresponding locations in the sequence of locations.

### BACKGROUND

1. Field of the Technology

At least some embodiments of the disclosure relate generally to the field of navigation and, more particularly but not limited to managing and presenting video, images, text and audio information associated with one or more locations on a trip.

2. Description of the Related Art

When someone travels, they may bring one or more devices such as a personal digital assistant (PDAs), cell phone, camera, and global positioning system (GPS) device. Personal digital assistants can be used to store travel itineraries. GPS devices can be used to provide routing information. Cameras can be used to capture images. And cell phones can be used to communicate by voice and text messages.

### SUMMARY

A method, machine-readable medium and apparatus for determining a sequence of locations; generating one or more objects, each of the one or more objects being at least partially generated at one or more corresponding locations in the sequence of locations; and associating each of the objects with at least one of the one or more corresponding locations in the sequence of locations.

### BRIEF DESCRIPTION OF THE DRAWINGS

These and other features, aspects, and advantages of the disclosure will become better understood with regard to the following description, appended claims, and accompanying drawings where:

FIG. 1 illustrates an embodiment of a portable device.

FIG. 2 shows a flow chart of one embodiment of a trip capture process.

FIG. 3 illustrates one embodiment of a trip object.

FIG. 4 illustrates one embodiment of a playback device.

FIG. 5 illustrates one embodiment of a playback display.

FIG. 6 illustrates one embodiment of a playback process.

FIG. 7 shows a diagrammatic representation of an embodiment of a machine within which a set of instructions, for causing the machine to perform any one or more of the methodologies discussed herein, may be executed.

### DETAILED DESCRIPTION OF PREFERRED EMBODIMENTS

The following description and drawings are illustrative and are not to be construed as limiting. Numerous specific details are described to provide a thorough understanding of the disclosure. However, in certain instances, well known or conventional details are not described in order to avoid obscuring the description. References to one or an embodiment in the present disclosure can be, but not necessarily are, references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

At least some embodiments of the disclosure relate to recording, reviewing and sharing images, videos, text and audio objects in association with various locations within a trip.

In at least some embodiments, a portable device is carried with one or more persons during a trip to capture images, video, voice, text and other information, determine the location of the portable device at the time the object is captured, and associate the captured objects with the corresponding locations. For example, the portable device can be used to capture a photo while the user is at a first location, capture the user's voice at a second location, and capture a video at a third location.

The sequence of locations is an indication of the travel path during the trip. Each of the captured objects represent a record of an event during the trip. This information can be associated with a trip and played back to create a multimedia experience of the trip. For example, a playback device may present the captured objects in an order consistent with the sequence of locations. In this way, the viewer may experience these captured objects, such as photos, videos, voice commentary, and text messages, in a way that may give the viewer a sense of having been on that trip. Furthermore, the traveler may be able to re-experience the trip by viewing these sights and sounds in the sequence of the trip.

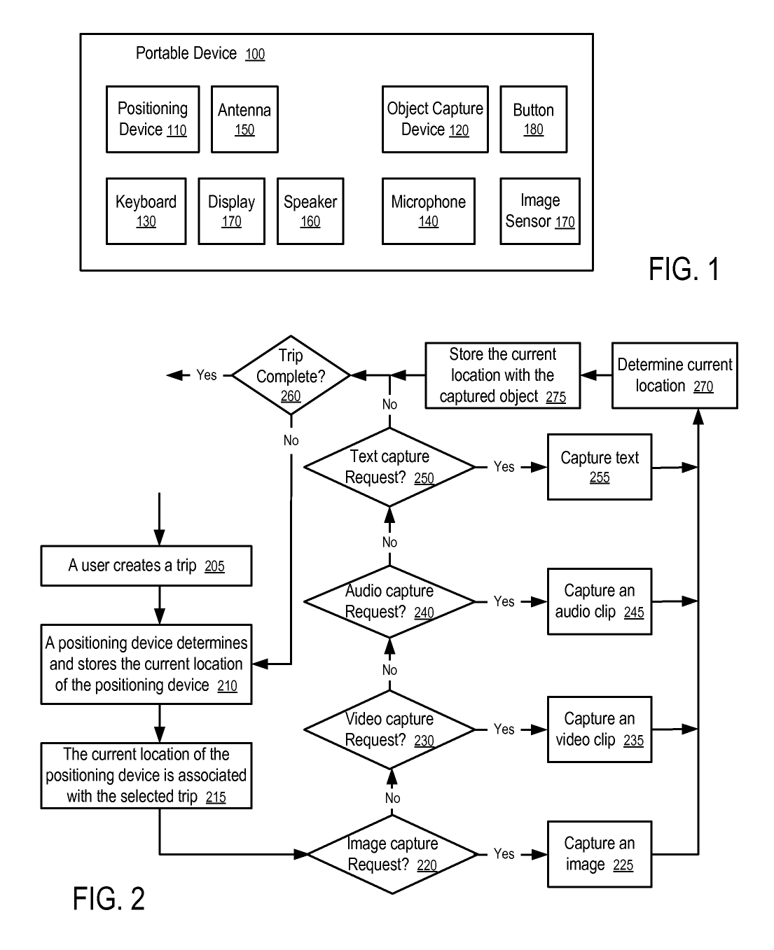

FIG. 1 illustrates an embodiment of a portable device 100. In some embodiments, the portable device 100 includes a positioning device 110 (internal), an object capture device 120 (internal), a keyboard 130, microphone 140, speaker 160, display 170 and antenna 150.

The positioning device 110 is configured to determine the position of the portable device 100. In some embodiments, the positioning device 110 is coupled to the antenna 150 to communicate with a global positioning system (GPS) to determine the location of the positioning device 100. In other embodiments, the positioning device 110 is coupled to the antenna 110 to communicate with a long range navigation (LORAN) system to determine the location of the portable device 100.

In one embodiment, in response to a user clicking a button 180, the object capture device 120 may capture an image through the image sensor 170 and a lens on the back (not shown) of the portable device 100 and associate that image with the current position of the portable unit 100 as determined by the positioning device 110.

In one embodiment, in response to a user clicking a button 180 (and/or a separate button, not shown), the object capture device 120 may capture and process a video through the image sensor 170 and the lens on the back of the portable device 100 and associate that video with the current position of the portable unit 100 as determined by the positioning device 110.

In one embodiment, in response to a user clicking a button 180 (and/or a separate button, not shown), the object capture device 120 may capture an audio signal through the microphone 140 and associate that audio with the current position of the portable unit 100 as determined by the positioning device 110.

In one embodiment, in response to a user clicking a button 180 (and/or a separate button, not shown), the object capture device 110 may capture and process text through the keyboard 130 and associate that text with the current position of the portable unit 100 as determined by the positioning device 110.

In other embodiments, one or more of the object capture processes is initiated through other means such as menu system or voice commands.

In some embodiments, the portable device 100 is a cellular telephone including a global positioning (GPS) device and digital camera.

In one embodiment, once the portable device 100 is activated in a trip mode, the portable device 100 automatically records the trip parameters, such as time, location, and speed at various points of the trip. The portable device 100 further records the objects captured via the image sensor 170 and the microphone 140 in response to user input (e.g., selecting the button 180) and automatically associates the captured objects with various points in the trip.

In one embodiment, the portable device 100 is a navigational GPS device that enables the user to record the experience during a trip, from a starting point to an end point and, any time during the trip, record audio and/or visual aspects of the trip so that, when the trip is played back, the user has a more vivid memory of the trip, as if the user was reliving the same experience of the original user that recorded the trip. In one embodiment, the recorded trip can be displayed on the active map to allow the user to follow along by walking through the earth. The recorded trip can be played back on the navigational GPS device, or on a personal computer.

FIG. 2 shows a flow chart of one embodiment of a trip capture process. In some embodiments, the process is implemented using an apparatus according to the embodiment illustrated in FIG. 1.

In process 205, a user creates a trip. In one embodiment, the user can use the portable device 100 to create a trip and capture objects related to the trip without having to log into an account. The portable device 100 stores the captured objects and the location information related to the trip. Alternatively, the user may logs into a personal account. For example, the user may enter user name and password using a keyboard on the handheld device. In some embodiments, a real name and email address is also associated with the user account. In one embodiment, after the user logs into the personal account, the captured objects and location information about the trip are automatically transmitted to a server via a wireless connection; thus, the captured objects and location information about the trip automatically becomes available from the server. In some embodiments, the user may capture the entire trip experience using the portable device 100 and subsequently upload the data related to the captured trip experience to a server for sharing.

In one embodiment, creating a trip includes specifying a name associated with a travel plan. For example, if the user is going to perform a walking tour of the west side of manhattan, the user might name the trip “west side.” In some embodiments, multiple trips may be created. For example, the user may also create an “east side” trip corresponding to a walking tour of the east side of Manhattan. In some embodiments, the user may select one of several preexisting trips instead of creating a trip. Switching back and forth between several trips may allow a user to suspend trips. For example, halfway through the walking tour of the west side, the user may travel to the east side to start or continue the walking tour of the east side by selecting the “east side” trip.

In some embodiments, information describing the trip is submitted and associated with the trip. For example, the information may include a description of the trip as entered by the user before or after the trip. Other objects, such as photos, videos, audio and text, may be provided by the user and associated with the trip as a whole rather than a particular location. For example, an audio sequence may provide some introductory comments about the trip.

In process 210, a positioning device determines and stores the current location of the positioning device. In some embodiments, the positioning device is a GPS device. In other embodiments, the positioning device is a long range navigation device. However other methods and devices for determining position may be used.

In process 215, the current location of the positioning device is associated with the selected trip. For example, the location may be associated with the “east side” trip. Over time, a sequence of locations may be associated with a trip. This sequence of locations represents a travel path associated with the selected trip. In embodiments having multiple trips, a first sequence of locations may be associated with a first trip and a second sequence of locations may be associated with a second trip. In some cases, times at which each location was determined and stored is also associated with the corresponding locations. Each position may be stored as a waypoint or part of a track, trail or route, for example.

In one embodiment, the positioning device periodically determines the current location and stores the current location with the selected trip. Alternatively, the position device may monitor the change in current position and stores information about current locations at characteristic points, such that the route, trail or track of can be reconstructed from the characteristic points. For example, the portable device may store the location of the turning points without storing the intermediate points along a street or trail.

In one embodiment, the positioning device stores the current location in response to a user request. For example, the user may push a button to record a current position.

In process 220, the portable device determines whether an image capture request has occurred. For example, the apparatus may include a digital camera with a photo button that initiates an image capture process. If an image capture request is received, process 225 is performed. If an image capture request is not received, process 230 is performed.

In process 225, the portable device captures an image in response to the image capture request. The apparatus generates an object that includes a representation of the image in a format such as a raw image format (RAW), tagged image format (TIF), or joint photographic experts group (JPEG), for example.

For the location of the captured image, in process 270, a positioning device determines and stores the current location of the positioning device. In some embodiments, the positioning device is a GPS device. In other embodiments, the positioning device is a long range navigation device. However, other methods and devices for determining position may be used. In process 275, the current location of the positioning device is associated with the captured image. Each location may be stored as a waypoint or part of a track, trail or route, for example.

In process 230, the portable device determines whether a video capture request has occurred. For example, the portable device may include a digital camcorder with a video capture button that initiates a video capture process. If a video capture request is received, process 235 is performed. If a video capture request is not received, process 240 is performed.

In process 235, the portable device captures a video in response to the video capture request. The apparatus generates an object that includes a representation of the video in a format such as motion picture experts group 2 (MPEG-2) format, digital video (DV) format, or high definition video (HDV) format, for example.

For the location of the captured video, in process 270, a positioning device determines and stores the current location of the positioning device. In some embodiment, the position corresponds to the location at the time of the video capture request. In other embodiments, the location may be the location of the positioning device at a moment during the video capture sequence such as the start or end of the video capture process. In yet other embodiments, more than one location may be determined corresponding to represent the movement during the video capture process. In process 275, the current location of the positioning device is associated with the captured video. Each location may be stored as a waypoint or part of a track, trail or route, for example.

In process 240, the portable device determines whether an audio capture request has occurred. For example, the apparatus may include a microphone with an audio capture button that initiates an audio capture process. If an audio capture request is received, process 245 is performed. If an audio capture request is not received, process 250 is performed.

In process 245, the portable device captures audio in response to the audio capture request. The apparatus generates an object that includes a representation of the audio in a format such as motion picture experts group 1 audio layer 3 (MP3) format, waveform audio (WAV) format, windows media audio (WMA) format, for example.

For the location of the captured video, in process 270, a positioning device determines and stores the current location of the positioning device. In some embodiments, the position corresponds to the location at the time of the audio capture request. In other embodiments, the location may be the location of the positioning device at a moment during the audio capture sequence such as the start or end of the audio capture process. In yet other embodiments, more than one location may be determined corresponding to represent the movement during the audio capture process. In process 275, the current location of the positioning device is associated with the captured audio. Each location may be stored as a waypoint or part of a track, trail or route, for example.

In process 250, the portable device determines whether text capture request has occurred. For example, the apparatus may include a keyboard with a button that initiates an text capture process. If a text capture request is received, process 255 is performed. If a text capture request is not received, process 260 is performed.

In process 255, the portable device captures text in response to the text capture request. The apparatus generates an object that includes a representation of the text in a format such as American standard code for information exchange (ASCII), for example. In some embodiments, an editor is provided to allow the user to compose a text message.

For the location of the captured text, in process 270, a positioning device determines and stores the current location of the positioning device. In process 275, the current location of the positioning device is associated with the captured text. Each location may be stored as a waypoint or part of a track, trail or route, for example.

In some embodiments, the location of the portable device is periodically determined and associated with the trip regardless of whether there is an associated capture event. In other embodiments, the location of the portable device is associated with the trip when it differs from the last associated position by a minimum predetermined distance. In yet other embodiments, a logical combination of one or more factors may be used to trigger associating the location of the portable device with the trip or a captured object.

In process 260 it is determined if the trip is completed. If the trip is not completed, process 210 is performed. Otherwise, the process is completed.

In some embodiments, objects are added to a preexisting trip. For example, the user may want to add an image captured using a digital camera that does not incorporate an embodiment of the trip capture functionality described herein. The user can transfer the image from the camera to the capture or playback device. In some embodiments, the user can associate that image with a particular location in a particular trip. In other embodiments, the user can associate that image with a particular location in a particular trip. The transfer can be performed by transferring the image to the portable device over a wired or wireless network, for example.

In some embodiments, the user may select an object, a trip and a location and click a button to indicate that the object should be associated with the selected location in the selected trip. In some embodiments, information such as video, images, text and audio are associated with the trip as a whole, not any particular location.

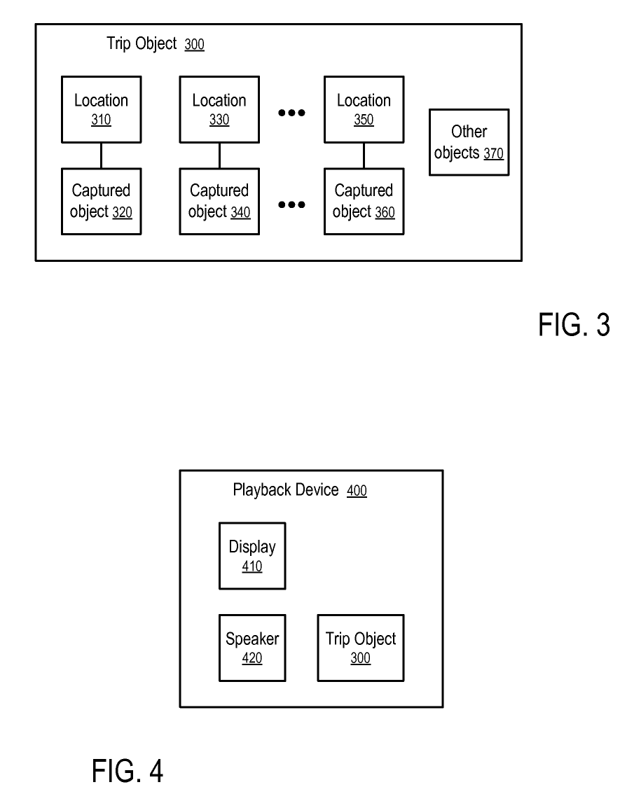

FIG. 3 illustrates one embodiment of a trip object. The trip object 300 contains the information associated with the captured trip. This trip object may be stored on a machine-readable medium in the capture device and stored on a machine-readable medium in playback device, for example.

In some embodiments, the trip object 300 includes the sequence of locations 310, 330, . . . , 350, captured objects 320, 340, . . . , 360, and the associations between captured objects and at least one location in the sequence of locations. For example, each captured object may be associated with one location; and one location may be associated with multiple captured objects when these objects are captured at the vicinity of the same location. Other objects 370 may be included in the trip object such as captured objects associated with the trip but not associated with any particular location in the sequence of locations, the name of the trip, introduction or comments about the trip, etc. In one embodiment, the trip object 300 further includes trip parameters, such as starting date, ending date, length, duration, average speed, maximum speed, highest altitude, etc. In one embodiment, the portable device 100 automatically updates and stores the trip parameters while the trip is active. During an active trip, the user can create waypoints, tracks, trails, and routes, voice-record important fun details into the microphone 140 and take pictures of sights using the image sensor 170 to record a multimedia experience of the trip.

FIG. 4 illustrates one embodiment of a playback device. In one embodiment, the playback device 400 is a computer system having a display 410 and speakers 420. The playback device is used to playback the trip object 300 according to an embodiment of the playback process described herein.

In some embodiments, the playback device accesses the trip object locally from a machine-readable medium. In other embodiments, the trip object is posted on a web page or blog. A user accesses the web page using a computer running a browser. The user selects an icon representing the trip object to cause the trip object to be retrieved by the computer and processed by playback software to perform one embodiment of a playback process as described herein.

In other embodiments, the playback process is performed by the portable device used to capture the trip, such as the one illustrated in FIG. 1.

In another embodiment, the trip object may be captured using a cellular telephone and transmitted over a network to a central server. A user logs into the central server using a playback device to access the trip object. A playback device 400 can be a personal computer, television, or other device capable of presenting the trip according to an embodiment of the playback process described herein.

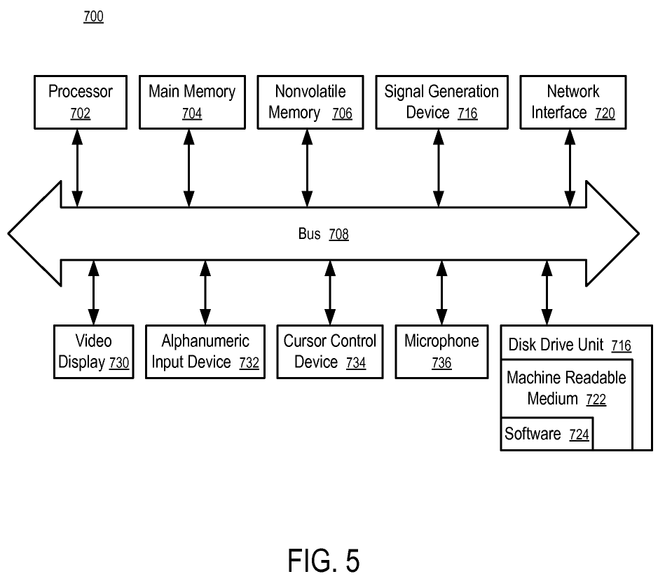

FIG. 5 illustrates one embodiment of a playback display.

In some embodiments, the playback process presents a map 510 including markers 520, 530, . . . , 540 corresponding to at least some of the sequence of locations associated with the captured trip and one or more icons 512, 514, . . . , 516 associated with objects captured during the trip as well as a graphical indication of the location associated with each object. The graphical indication of the association may be the placement of the object icons near the markers, or a line between the object icon and the marker of the associated location.

A user can select an icon on the map to present the associated object. The user clicks on an icon representing an image, to display the image. The user clicks on an icon representing video, to display the video. The user clicks on an icon representing an audio signal, to generate the audio signal. The user clicks on an icon representing text, to display the text. The user can select objects in any order they want regardless of the sequence the objects were captured in.

In one embodiment, the user can manage trips, add or remove user objects to trips and turn trip feature on or off on the portable device 100. A high level description can be added to the trip to document the trip as free text, including any other pertinent information about the particular trip.

In one embodiment, while viewing user objects associated with particular trip, the user can filter objects by object type. The recorded trips can be published and shared on online. Once the trip is shared with others, it becomes a “geo-blog”.

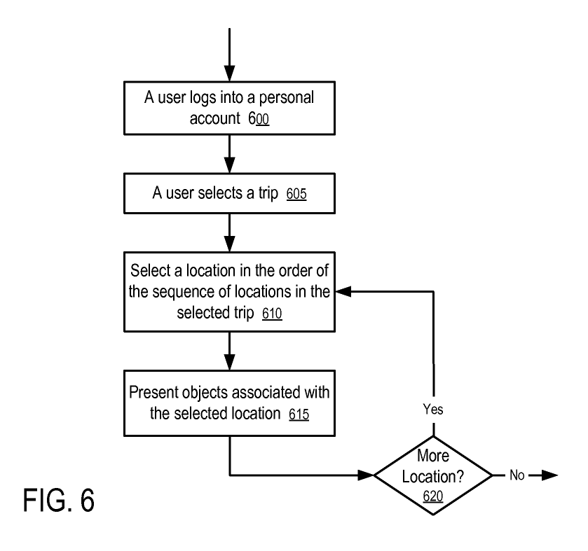

FIG. 6 illustrates one embodiment of a playback process.

In process 600, a user logs into a personal account. For example, the user may enter a user name and password using a keyboard on the playback device.

In process 605, a user selects a captured trip for playback. In one embodiment, the user selects the captured trip from among several captured trips available to their user account. These captured trips may include trips captured by that user and trips captured by other users and made available to this user. Trips captured by other users may be made directly available to this user by transmitting the captured trip to this user directly via email or other means of file transfer, for example. In other embodiments, other users can transmit a captured trip to a central server and create access permissions that allow this user to access that captured trip.

In process 610, a location is selected in the order of the sequence of locations associated with the selected trip. In some cases, details of the selected location are presented, such as GPS position data.

In process 615, one or more objects associated with the selected location is presented. For example, one or more videos, images, audio and text captured at that location may be presented. In some cases, the associated objects are presented in sequence according to their sequence of capture. In other cases, some or all of the associated objects are presented in parallel, such as a photo montage, or playing back captured audio while displaying one or more captured images.

In process 620, it is determined whether there are any more locations in the sequence of locations associated with the selected trip.

In process 625, if there are any more locations in the sequence of locations associated with the selected trip, process 610 is performed. Otherwise, the process is completed.

In some embodiments, the user specifies one or more options that control the playback process. For example, the user may select the time allocated for display of images and text, whether images associated with a particular location are displayed in sequence or in parallel. In some embodiments, playback control functions such as pause, fast forward and rewind, are used to control the playback process.

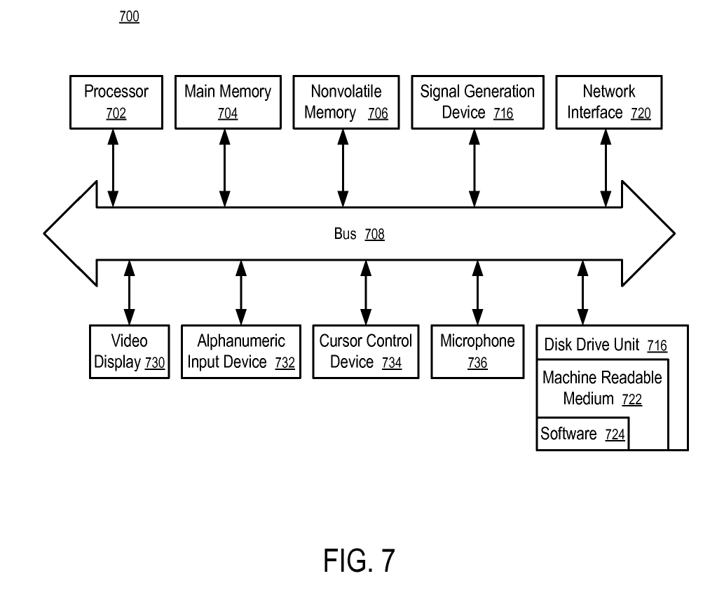

FIG. 7 shows a diagrammatic representation of an embodiment of a machine 700 within which a set of instructions, for causing the machine to perform any one or more of the methodologies discussed herein, may be executed. The machine may be connected (e.g., networked) to other machines. In a networked deployment, the machine may operate in the capacity of a server or a client machine in a client-server network environment, or as a peer machine in a peer-to-peer (or distributed) network environment. In one embodiment, the machine communicates with the server to facilitate operations of the server and/or to access the operations of the server.

In some embodiments, the machine is a capture device as described herein. In other embodiments, the machine is a playback device as described herein. In yet other embodiments, the machine has the capabilities of both a capture device and playback device as described herein.

The machine 700 includes a processor 702 (e.g., a central processing unit (CPU) a graphics processing unit (GPU) or both), a main memory 704 and a nonvolatile memory 706, which communicate with each other via a bus 708. In some embodiments, the machine 700 may be a desktop computer, a laptop computer, personal digital assistant (PDA) or mobile phone, for example. In one embodiment, the machine 700 also includes a video display 730, an alphanumeric input device 732 (e.g., a keyboard), a cursor control device 734 (e.g., a mouse), a microphone 736, a disk drive unit 716, a signal generation device 718 (e.g., a speaker) and a network interface device 720.

In one embodiment, the video display 730 includes a touch sensitive screen for user input. In one embodiment, the touch sensitive screen is used instead of a keyboard and mouse. The disk drive unit 716 includes a machine-readable medium 722 on which is stored one or more sets of instructions (e.g., software 724) embodying any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media. The software 724 may further be transmitted or received over a network 740 via the network interface device 720.

While the machine-readable medium 722 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media.

In general, the routines executed to implement the embodiments of the disclosure, may be implemented as part of an operating system or a specific application, component, program, object, module or sequence of instructions referred to as “programs.” For example, one or more programs may be used to execute specific processes described herein. The programs typically comprise one or more instructions set at various times in various memory and storage devices in the machine, and that, when read and executed by one or more processors, cause the machine to perform operations to execute elements involving the various aspects of the disclosure.

Moreover, while embodiments have been described in the context of fully machines, those skilled in the art will appreciate that the various embodiments are capable of being distributed as a program product in a variety of forms, and that the disclosure applies equally regardless of the particular type of machine or computer-readable media used to actually effect the distribution. Examples of machine-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although embodiments have been described with reference to specific exemplary embodiments, it will be evident that the various modification and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method comprising:
determining a sequence of locations;
generating objects of different multimedia types, each of the objects being at least partially generated at one or more corresponding locations in the sequence of locations; and
associating each of the objects with at least one of the one or more corresponding locations in the sequence of locations.

2. The method of claim 1 wherein the sequence of locations is determined using at least one of a global positioning device and a long range navigation device.

3. The method of claim 1 wherein the sequence of locations track the movement of a positioning device over a period of time.

4. The method of claim 1 wherein at least one of the objects comprises an image, generating the object comprising generating the image.

5. The method of claim 1 wherein at least one of the objects comprises a video, generating the object comprising generating the video.

6. The method of claim 1 wherein at least one of the objects comprises audio, generating the object comprising generating the audio.

7. The method of claim 1 wherein at least one of the objects comprises text, generating the object comprising generating the text.

8. The method of claim 1 further comprising generating a trip object comprising the sequence of locations, one or more captured objects, and associations between the one or more captured objects and the sequence of locations.

9. The method of claim 1 further comprising associating the sequence of locations with a trip.

10. The method of claim 1 further comprising presenting a map having markers corresponding to one or more locations in the sequence of locations and a representation of at least one of the objects associated with the one or more locations in the sequence of locations.

11. The method of claim 9 wherein the representation of at least one of the objects comprises an icon, the method further comprising presenting an alternate representation of the at least one object in response to the user selecting the icon.

12. The method of claim 11 wherein the alternate representation comprises at least one of an image, video, audio, and text.

13. A machine-readable medium that provides instructions for a processor, which when executed by the processor cause the processor to perform a method comprising:
determining a sequence of locations;
generating one or more objects, each of the one or more objects being at least partially generated at one or more corresponding locations in the sequence of locations; and
associating each of the objects with at least one of the one or more corresponding locations in the sequence of locations.

14. The machine-readable medium of claim 13 wherein the sequence of locations is determined using at least one of a global positioning device and a long range navigation device.

15. The machine-readable medium of claim 13 wherein the sequence of locations track the movement of a positioning device over a period of time.

16. The machine-readable medium of claim 13 wherein at least one of the objects comprises an image, generating the object comprising generating the image.

17. The machine-readable medium of claim 13 wherein at least one of the objects comprises a video, generating the object comprising generating the video.

18. The machine-readable medium of claim 13 wherein at least one of the objects comprises audio, generating the object comprising generating the audio.

19. The machine-readable medium of claim 13 wherein at least one of the objects comprises text, generating the object comprising generating the text.

20. The machine-readable medium of claim 13 further comprising generating a trip object comprising the sequence of locations, one or more captured objects, and associations between the one or more captured objects and the sequence of locations.
